(19) United States
(12) Patent Application Publication
(10) Pub. No.: US 2010/0306683 A1
(43) Pub. Date: Dec. 2, 2010

(54) USER INTERFACE BEHAVIORS FOR INPUT DEVICE WITH INDIVIDUALLY CONTROLLED ILLUMINATED INPUT ELEMENTS

(75) Inventors: Aleksandar Pance, Saratoga, CA (US); Alex J. Crumlin, San Jose, CA (US); Nicholas Vincent King, San Jose, CA (US); Duncan Kerr, San Francisco, CA (US); James E. Orr, IV, Cupertino, CA (US)

Correspondence Address: DORSEY & WHITNEY LLP;on behalf of APPLE, INC., 370 SEVENTEENTH ST., SUITE 4700, DENVER, CO, 80202-5647, US

(73) Assignee: Apple Inc., Cupertino, CA (US)

(21) Appl. No.: 12/476,040

(22) Filed: Jun. 1, 2009

(51) Int. Cl. G06F 3/048

(52) U.S. Cl. 715/764; 345/156

(57) ABSTRACT

Methods and apparatuses are disclosed that provide user interface behaviors for input devices with individually controlled illuminated input elements. Some embodiments may include receiving a request for input device lighting from a program, determining illumination information for light sources coupled to input elements of an input device based on the request, and dynamically controlling illumination of the light sources based on the illumination information. The illumination information may include brightness, color, and/or duration. The input device may constitute a keyboard with individually controlled illuminated keys. In some embodiments, the illumination may present information related to the program, functionality of input elements, and/or notifications. The request for input device lighting from the program may be based on input selections received from the input device such as illuminating keys on a keyboard that are possible next letters in a word being typed or keys associated with a pressed command key.

### CROSS-REFERENCE TO RELATED APPLICATIONS

The following related patent applications are hereby incorporated by reference in their entirety as if set forth fully herein: U.S. patent application Ser. No. ______ (Attorney Docket No. P7400US1 (191162/US)), titled “Light Source With Light Sensor” and filed concurrently herewith; U.S. patent application Ser. No. ______ (Attorney Docket No. P7332US1 (191159/US)), titled “Keyboard With Increased Control of Backlit Keys” and filed concurrently herewith; and U.S. patent application Ser. No. ______ (Attorney Docket No. P7402US1 (191158/US)), titled “White Point Adjustment For Multicolor Keyboard Backlight” and filed concurrently herewith.

### TECHNICAL FIELD

The present invention relates generally to user interface behaviors for input devices, and more particularly to dynamic and individual control of backlighting for input elements within an input device.

### BACKGROUND

Electronic devices are ubiquitous in society and can be found in everything from wristwatches to computers. While electronic devices such as computers operate in a world of ones and zeros, human beings do not. Thus, many computers include intermediary devices that allow human beings to interface to the computer. One such device is the keyboard where the user interfaces with the computer by pressing certain keys and then watching a display device connected to the computer to determine if the user's desired response was achieved.

While most conventional approaches utilize keyboards and other intermediary devices as strict input devices, some devices may convey output information to the user of the computer via the keyboard. For example, when a user presses the CAPS lock key, a light at the top of the keyboard (or on the CAPS lock key itself) may light up to indicate that such a selection has been made. Alternatively, some conventional approaches may provide a keyboard that associates lights with its keys where the keyboard may be statically configured at boot time.

### SUMMARY

Methods and apparatuses are disclosed that provide user interface behaviors for input devices with individually controlled illuminated input elements. Some embodiments may take the form of a method, including the operations of: receiving a request for input device lighting from a program executing on a computing device; determining illumination information for one or more light sources coupled to one or more input elements of the input device based on the request; and dynamically controlling illumination of the one or more light sources based on the determined illumination information. The illumination information may include brightness, color, and/or duration of the one or more light sources. The input device may constitute a keyboard with individually controlled illuminated keys.

In some embodiments, the illumination of the light sources may present information related to a program in operation on an associated computing device. For example, the light sources may function as a graphic equalizer on an input device or generally relate to at least a portion of an image on a display device. In other embodiments, the illumination of light sources may indicate or change functionality of a program utilizing the input elements. For example, input elements can be utilized to access functionality of a first-person shooter game. In still other embodiments, the illumination of the light sources may present a notification associated with the program such as an “E” key on a keyboard to indicate that an email has been received by an email application.

In some embodiments, the request for input device lighting from the program may be based on input selections received from the input device. For example, a program may receive keystrokes from a keyboard that constitute a portion of a word and the program may request input device lighting to illuminate keys on the keyboard that are possible next letters in the word. By way of another example, a program may receive a command key keystroke from a keyboard and the program may request input device lighting to illuminate keys on the keyboard that are associated with the command key.

### BRIEF DESCRIPTION OF THE DRAWINGS

FIG. 1 illustrates a desktop computing system.

FIG. 2 illustrates a laptop computing system.

FIG. 3 illustrates a block diagram of the desktop computing system of FIG. 1.

FIG. 4 illustrates a method of presenting user interface behaviors on an input device with individually controlled illumination input elements.

FIG. 5 illustrates a sample software and hardware configuration that may present user interface behaviors on an input device with individually controlled illumination input elements.

FIG. 6 illustrates a sample presentation of user interface behaviors on a keyboard with individually controlled illuminated keys.

FIG. 7 illustrates another sample presentation of user interface behaviors on a keyboard with individually controlled illuminated keys.

FIG. 8 illustrates a third sample presentation of user interface behaviors on a keyboard with individually controlled illuminated keys.

FIG. 9 illustrates a fifth sample presentation of user interface behaviors on a keyboard with individually controlled illuminated keys.

FIG. 10 illustrates a sixth sample presentation of user interface behaviors on a keyboard with individually controlled illuminated keys.

FIG. 11 illustrates a seventh sample presentation of user interface behaviors on a keyboard with individually controlled illuminated keys.

FIG. 12 illustrates an eighth sample presentation of user interface behaviors on a keyboard with individually controlled illuminated keys.

The use of the same reference numerals in different drawings indicates similar or identical items.

### DETAILED DESCRIPTION OF THE INVENTION

Embodiments are disclosed that allow presentation of user interface behaviors on an input device with individually controlled illuminated input elements. Some embodiments may facilitate dynamically controlling illumination of light sources coupled to, or forming a part of, one or more input elements of an input device based on an illumination request from a program executing on a computing device. The program may include system software (such as an operating system) or application software. For example, the program may include an operating system, a word processing program, and/or a first-person shooter game. In some embodiments, the request for input device lighting from the program may be based on input element selections received from the input device.

Although one or more of these embodiments may be described in detail in the context of a computer system, the embodiments disclosed should not be interpreted as limiting, or otherwise used to limit the scope of the disclosure, including the claims. In addition, one skilled in the art will understand that the following description has broad application. Accordingly, the discussion of any embodiment is meant only to be exemplary and is not intended to intimate that the scope of the disclosure, including the claims, is limited to these embodiments.

Embodiments described herein may provide various user experiences by using a keyboard, or other input device, to provide output as well. The individual keys of the keyboard may each be separately illuminated across a range of colors and brightnesses. Depending on the application and/or operation requesting or controlling illumination of the keys, the color and/or brightness of each lit key may convey a variety of information.

For example, the computing system may provide reactive feedback by lighting keys, such as lighting the key that has been or is being pressed. The embodiment may provide predictive feedback, such as illuminating keys that are likely to be pressed given prior keystrokes, the application interfacing with the keyboard, an application currently in use by the user, prior user activities and so on. To provide a concrete example, a word processor may operate to control lighting of the keys on a keyboard such that the next most likely letter to be pressed is illuminated. The word processor may determine this by tracking the keys already pressed and employing a dictionary function. In some embodiments, the word processor may clear its memory and begin tracking keystrokes anew every time the space bar in pressed.

As another example, the system may employ output via the keyboard for purposes of training or education, such as teaching a specific sequence of keystrokes to a user by illuminating them in a pattern. The pattern may be temporal, such that each key in the sequence is illuminated in turn according to the sequence. The previously-illuminated keys may remain lit, may dim, or may be extinguished entirely. The pattern may be related to color, so that each key is illuminated in a shade of the same color, with the shades becoming darker as the sequence progresses. Alternately, the colors may vary with the progression of the sequence. As one illustration, the first key in the sequence may be red, the next orange, the third yellow, the fourth green, and so on such that the color of the keys ranges along the colors of the spectrum from red to indigo as the sequence progresses.

As yet another example, embodiments may create visual effects by lighting the various keys of the keyboard or elements of another output device. “Running lights” may be simulated, keys may have color and/or intensity changed as the embodiment plays music, and so on.

Still another function that may be achieved by embodiments separately illuminating keys of a keyboard, as well as separately adjusting the brightness and color of such keys, is functional key grouping. Keys having similar functions in an application may be colored similarly or may have similar brightness. Different functional key groups may have different colors and/or brightnesses. As a user switches from one application or program to another, the functional key groups may change and thus the color and/or brightness of each key may change.

The embodiment may also contextually change illumination based on the current state of an application, operating system or software. For example, in an image application, a first set of keys may be illuminated when the application is operating in an image management mode. The first set of keys generally provides management functionality, such as saving, resizing, tagging, and so forth. If the user switches the application to run in a second mode, such as a slideshow mode, the functionality of the keys on the keyboard may change. Thus, the application may request the keyboard extinguish backlighting for the first set of keys and illuminate a second set of keys corresponding to the functions available in the slideshow mode. Further, the context of the application function may affect the illumination brightness as well. As an example, keys may be more softly illuminated (or illuminated in a darker color) during a slideshow mode than during a management mode in order to reduce the likelihood of distraction. It should be understood that this contextual illumination may occur when any application experiences or provides a change in functionality. As yet another example, opening a menu on a word processing program may cause the keys corresponding to the functions of that menu to illuminate.

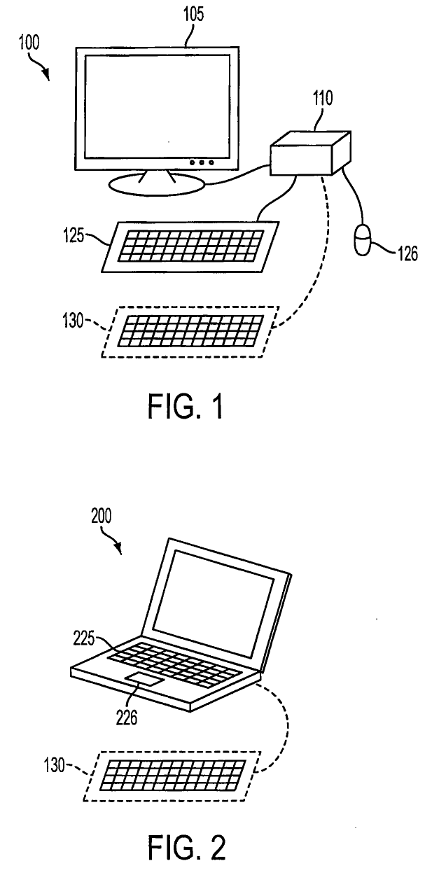

FIG. 1 illustrates a desktop computing system 100 capable of presenting user interface behaviors on an input device. The system typically includes a display device 105 coupled to a computing device 110. The computing device 110 may couple to one or more input devices such as a keyboard 125 and/or mouse 126. (The keyboard 125 may include a keyboard with enhanced control of backlit keys as disclosed in “Keyboard with Increased Control of Backlit Keys,” filed on the same date as this application and identified as attorney docket no. P7332US (191151US)). During operation, the computing system 100 generally executes application programs and/or operating system (OS) software. The computing system 100 may execute the application programs or OS at least partially under the direction of a user. The user may interact with the application programs or OS via the keyboard 125 and/or mouse 126. As will be described in further detail below, while the keyboard 125 and/or mouse 126 are conventionally used as input devices, the keyboard 125 and/or mouse 126 may be utilized to present user interface behaviors, such as by illuminating the keys of the keyboard 125 and/or the buttons of the mouse 126.

Depending upon the embodiment, the keyboard 125 and mouse 126 may take a variety of forms. For example, in some embodiments the keyboard 125 may be a 101-key US traditional keyboard configured to support the English language while the mouse may be a PS2 style. However, in alternative embodiments the keyboard 125 may be a 102/105-key International keyboard configured to support non-English languages. In still other embodiments, the keyboard 125 may provide multimedia support, with special keys for accessing and controlling multimedia files.

While FIG. 1 depicts the keyboard 125 and mouse 126 coupled to the computing device 110 via a hardwired connection, it should be appreciated that the keyboard 125 and mouse 126 may couple to the computing device wirelessly, such as via an infrared and/or Bluetooth connection. Also, optional redundant input devices, such as redundant keyboard 130, may be used to provide greater flexibility in operation of the computing device 110. For example, the keyboard 125 and the keyboard 130 may be used by separate users, both of whom may be concurrently using the computing system 100.

Some embodiments may implement the computing device 110 as a Mac™ manufactured by Apple Inc.™. For example, the computing device 110 may be a Mac Mini™ and the OS may be Mac OS™ version 10.

FIG. 2 illustrates an alternative embodiment where the computing system is implemented as a laptop system 200, such as the MacBook Pro™, where a keyboard 225 and mouse 226 are integrated in the laptop system 200. Similar to the desktop computing system 100, optional redundant input devices, such as redundant keyboard 130, may be used to provide greater flexibility in operation of the laptop system 200. For example, the keyboard 225 and the keyboard 130 may be used by separate users, both of whom may be concurrently using the laptop system 200.

Of course alternative embodiments are possible where the computing system 100 is not a personal computer. For example, the computing system 100 may be a gaming system, such as the X-Box™ manufactured by Microsoft, Inc.™, the Playstation™ manufactured by Sony, Inc.™, and/or the Wii™ manufactured by Nintendo™. By way of another example, the computing system 100 may be a cellular telephone or personal digital assistant, such as the Razr V3™ manufactured by Motorola™ or the Bold™ manufactured by RIM™. As will be appreciated by one of skill in the art, the input devices, such as the keyboard 125 and mouse 126, may take a variety of forms depending upon the actual implementation of the computing system 100. For example, in embodiments where the computing system 100 is a gaming system, the input devices may be game controllers with dynamic illumination operations akin to the keyboard 125 and mouse 126 (which are described in further detail below).

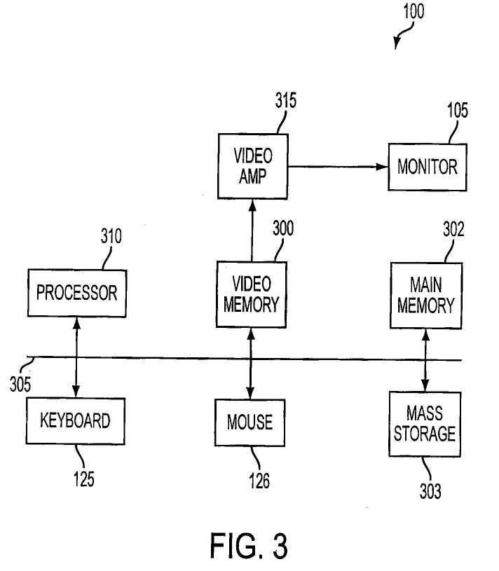

FIG. 3 illustrates a sample block diagram of the desktop computer system 100 described above in the context of FIG. 1. The system 100 may include a video memory 300, a main memory 302 and a mass storage 303, all coupled to a system bus 305 along with the keyboard 125, mouse 126 and processor 310. The mass storage 303 may include both or either of fixed and removable media, such as flash drives, magnetic, optical or magnetic-optical storage systems and any other available mass storage technology. The bus 305 may include, for example, address lines for addressing video memory 300 or main memory 302. The system bus 305 also may include, for example, a data bus for transferring data between and among the components, such as processor 310, main memory 302, video memory 300, and mass storage 303. The video memory 300 may be a dual-ported video random access memory. One port of the video memory 300, in one example, is coupled to a video amplifier 315, which is used to drive the display device 105. The display device 105 may be any type of monitor suitable for displaying graphic images, such as a cathode ray tube monitor (CRT), flat panel, or liquid crystal display (LCD) monitor or any other suitable data presentation device.

In some embodiments, processor 310 is a microprocessor manufactured by Motorola™, such as the 680XX0 processor, or a microprocessor manufactured by Intel, such as the 80X86 (Pentium®), Core™ 2 Duo, or Xeon™ processors. Any other suitable microprocessor or microcomputer may be utilized, however.

Depending upon the embodiment, the bus 305 may take the form of multiple independent busses. For example, the bus 305 may couple a processor 310 to a Northbridge chip, where the Northbridge chip generally controls functions like the main memory 302 and video memory 300. Another bus 305 may couple the Northbridge chip to a Southbridge chip to control operation of the keyboard 125, mouse 126, and/or other peripheral devices.

During operation, code received by system 100 may be executed by the processor 310 as it is received, and/or stored in the mass storage 303, or other non-volatile storage for later execution. In this manner, the system 100 may access application programs or OS software stored in a variety of forms. Application programs may be embodied in any form of computer program product, such as a medium configured to store or transport computer readable code or data, or in which computer readable code or data may be embedded. Examples of computer program products include CD-ROM discs, ROM cards, floppy disks, magnetic tapes, computer hard drives, servers on a network, and solid state memory devices.

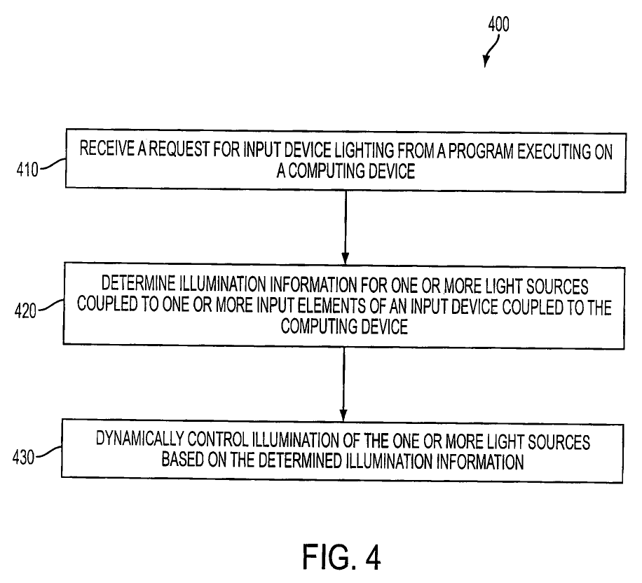

FIG. 4 illustrates a method 400 of presenting user interface behaviors on an input device with individually controlled illumination input elements that may be performed by system 100, in accordance with some embodiments of the present disclosure. The method 400 may be implemented on a computer and performed by a processing unit, such as the processing unit 310, executing one or more sets of instructions included in a computer program product stored in a machine-readable medium, such as main memory 302 and/or the mass storage 303.

In a first operation 410, an input device lighting driver, executing on a computing device, receives a request for input device lighting from a program executing on the computing device. The program may include any program executing on the computing device, such as an application program and/or the OS. In some embodiments, the request for input device lighting may be based on input element selections received from the input device and provided to the program.

The program may request for input device lighting to accomplish a variety of purposes. These purposes may include, but are not limited to: displaying graphical information related to the program; displaying, mirroring or approximating, at least a portion of an image currently displayed on a display device coupled to the computing device; conveying information regarding functionality of the program related to input elements of the input device; conveying assistance regarding functionality of the program, conveying assistance regarding use of the program, conveying information related to the status of the program; presenting a notification associated with the program; and conveying information regarding certain functionality of input elements of the input device related to the program and already selected input elements of the input device (such as a command key).

In a second operation 420, the input device lighting driver determines illumination information for one or more light sources coupled to one or more input elements of an input device coupled to the computing device. The illumination information may include a brightness of the one or more light sources, a color of the one or more light sources, and/or a duration of the one or more light sources.

In a third operation 430, the input device lighting driver dynamically controls illumination of the one or more light sources based on the determined illumination information. For example, based on the illumination information determined in operation 420, the input device lighting driver may transmit a red-green-blue (RGB) value for the one or more light sources to the input device for a particular duration.

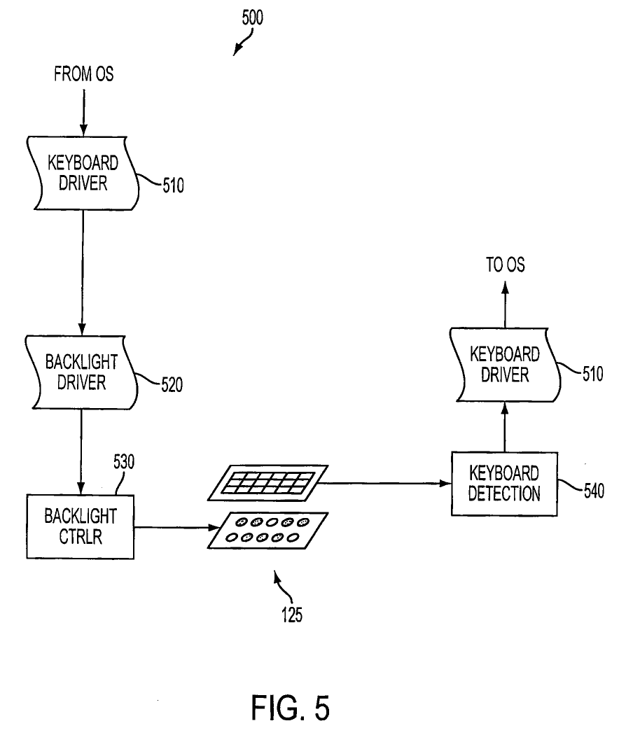

FIG. 5 illustrates a potential configuration for various software and/or hardware elements 500 of the computer system 100 described above. For ease of discussion, FIG. 5 refers only to the keyboard 125 (which constitutes a keyboard with increased control of backlit keys as disclosed in “Keyboard with Increased Control of Backlit Keys,” filed on the same date as this application and identified as attorney docket no. P7332US (191151US)). However, as was mentioned previously, numerous input devices are possible. While conventional keyboards are often used as input devices, it is possible to configure the computer system 100 such that the keyboard 125 may present user interface behaviors to the user.

At least a portion of the OS running on the computing device 110 may include a keyboard driver 510 that handles the individual color control of the backlighting source for one or more keys of the keyboard 125. The keyboard driver 510 may receive a request from the OS or an application program to illuminate one or more keys of the keyboard 125 via the associated light source. For example, if the user types all but the last letter of a word in a word processing program, a spell checker function of the word processing program may request the keyboard driver 510 to light the most probable last letter of the word being typed by the user.

As shown in FIG. 5, the keyboard driver 510 may couple to a backlight driver 520, which may be part of the OS in some embodiments. During operation, the keyboard driver 510 may send data to the backlight driver 520 in array form, such as an identifier associated with a particular key, a brightness associated with this key, a color associated with this key, as well as a duration of illumination for this key. Table 1 illustrates a potential array with this information for two keys of a sample keyboard.

TABLE 1

| Key | Brightness | Color | Duration |
|---|---|---|---|
| A | Medium | Red | 2 seconds |
| B | High | Blue | 1 second |

Although Table 1 illustrates potential signals for two keys, the array generated by the keyboard driver 510 may contain many entries. For example, in the event that the keyboard 125 is a 101-key US traditional keyboard, then the array may contain 101 entries each having a brightness, color, and/or duration. Furthermore, although Table 1 illustrates potential color illumination signals, non-color illumination signals (e.g., luminance only) are also possible.

It should be noted that the duration parameter shown in Table 1 is provided for convenience and is not necessary to control operation of any light source (such as a backlight for a key). An embodiment may instead vary the duration of a light source's activation by adjusting the PWM duty cycle for the light source, or for individual components of the light source such as individual red, green and/or blue LEDs. For example, in order to determine which keys should be illuminated at any given time, the keyboard driver 510 may provide updated values for the red, green and/or blue PWM values at a rate of N times per second, where N is chosen such that the human eye cannot discern any flickering. Thus, in one embodiment, N is greater than or equal to 60 so that the operating rate of the LED(s) is 60 Hz or greater.

The backlight driver 520 may couple to a backlight controller 530. In some embodiments, the backlight controller 530 may exist as a discrete integrated circuit within the keyboard 125, such as in the form of a keyboard controller of the keyboard 125. In other embodiments, the backlight controller 530 may exist as firmware stored in a read only memory (ROM) within a lighting controller of the keyboard 125. Regardless of the implementation of the backlight controller 530, the backlight driver 520 may generate data signals for programming the backlight controller 530.

In some embodiments, the data signals generated by the backlight driver 520 may be in array form as shown in Table 2, which is akin to the array shown in Table 1, yet more rudimentary than the array of data shown in Table 1. The more rudimentary nature of the data signals in Table 2 may be beneficial, for example, in the embodiments where the driver 520 is less complex and unable to directly process the data of Table 1. Again, although Table 2 illustrates potential signals for but a few keys, the array generated by the keyboard driver 510 may contain many entries, such as when the keyboard 125 is a 101-key US traditional keyboard.

As shown in Table 2, each individual key may have customized RGB values, current levels, and/or firing durations each red, green, and/or blue LEDs of each key of the keyboard 125. Notably, these customized values may vary as the keyboard 125 is dynamically controlled based upon user inputs.

TABLE 2

| Key ID | R, G, and/or B | Current Level | Duration |
|---|---|---|---|
| A | Red - 20% | Red - 5 mA | Red - 1 second |
| | Green - 50% | Green - 12.5 mA | Green - 2 seconds |
| | Blue - 10% | Blue - 2.5 mA | Blue - 3 seconds |
| B | Red - 70% | Red - 17.5 mA | Red - 7 seconds |
| | Green - 50% | Green - 12.5 mA | Green - 0.5 seconds |
| | Blue - 60% | Blue - 15 mA | Blue - 2 seconds |

The keyboard 125 also may include firmware or circuitry capable of detecting keystrokes and conveying this information back to the computing device 110 to allow requests to illuminate one or more keys of the keyboard 125 to be based on detected keystrokes. As with Table 1, certain embodiments may not require a duration parameter.

Regardless of whether reporting occurs via firmware or via dedicated circuitry, the keyboard driver 510 described above also may process data reported from the firmware or circuitry and report depressed key sequences back to the OS or application programs running on the computing device 110. Reporting the depressed keys and/or key sequences back to the OS and/or application programs running on the computing device 110 may allow generation of requests to illuminate one or more keys of the keyboard 125 that are interactively based upon inputs by the user. Thus, in the event that the user's inputs result in a request to illuminate one or more keys of the keyboard 125, the OS or application program may request dynamic key lighting.

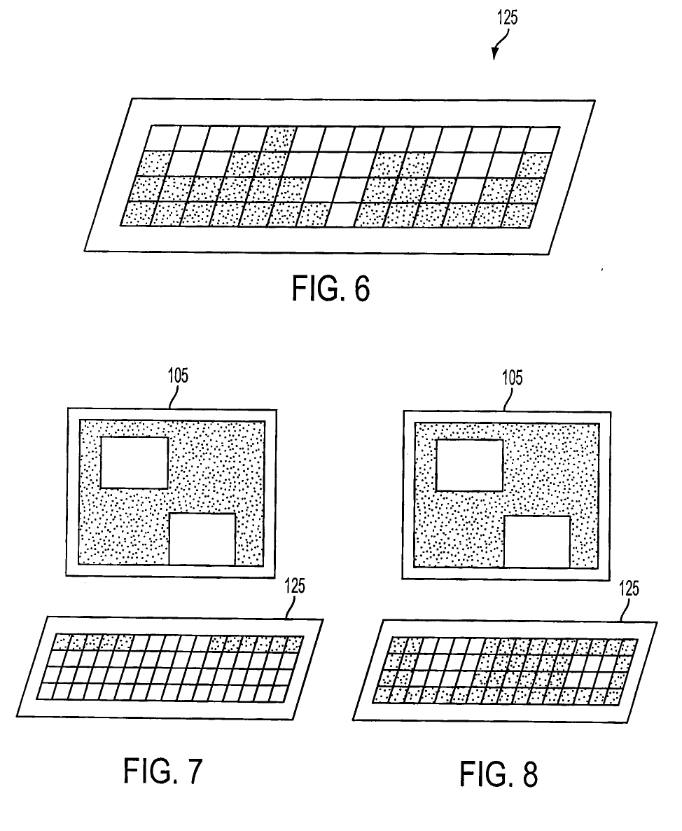

By way of an example, a application program executing on computing device 110 may request illumination of one or more keys of keyboard 125, as illustrated in FIG. 6, to present a graphic equalizer on keyboard 125. In this example, the application program may constitute a sound application and the keyboard 125 may vary illumination of the one or more keys to present a graphic equalizer for sound generated by the sound application. The sound application may be an audio player such as iTunes™ or Windows Media Player™. The sound application may also be composition software such as GarageBand™ or Sound Forge™. The sound application may select groups of keys to correspond different elements of the generated sound, such as different frequencies present in the generated sound. For example, the sound application may select a first row of keys to correspond to a first frequency present in the generated sound and a second row of keys to correspond to a second frequency present in the generated sound. The sound application may vary illumination of one or more of the first row of keys in relation to a decibel level of the first frequency and vary illumination of one or more of the second row of keys in relation to a decibel level of the second frequency. The sound application may also vary the rows of keys that correspond to the respective frequencies. If the sound application generates music, the keyboard may vary the illumination of one or more keys in time with the music or some element thereof. For example, the sound application may vary brightness and/or color of the one or more keys in relation to elements of the music, such as beat, frequency, tempo, etc. For example, if the keyboard 125 is configured to illuminate the number of keys in a row in relation to a decibel level of the music the sound application may pulse or flash the illuminated keys in time with the beat of the music.

By way of another example, the OS or application executing on computing device 110 may request illumination of one or more keys of the keyboard 125 to present a display on the keyboard 125 that corresponds to at least a portion of the image the OS or application is displaying on the display device 105. The OS or application may generate a point-to-point mapping of the portion of the image the OS or application is displaying on the display device 105 to the keyboard 125. The OS or application may generate the point-to-point mapping by overlaying a grid on the image where portions of the grid, defined by grid vertices, correspond to keys of the keyboard 125. The OS or application may sample a value for the area of the portion of the image that maps to a particular key (such as a median value or an average value for that area) based on the overlaid grid. Thus, the OS or application may request illumination of one or more keys based on the values for the areas mapping to the one or more keys. This illumination request may include both color and brightness data, as generally detailed herein.

FIG. 7 illustrates one or more embodiments of this example where the OS or application requests illumination of one or more keys of keyboard 125 to present a portion of the image displayed on display device 105 to generate the effect that the image displayed on display device 105 “bleeds” over onto keyboard 125. FIG. 8 illustrates one or more other embodiments of this example where the OS or application requests illumination of one or more keys of keyboard 125 to present the image displayed on display device 105 to generate the effect that the image displayed on display device 105 is “reflected” onto keyboard 125. In order to create this bleed effect, the intensity, as well as the color, of light emitted by the various light sources may be varied by the embodiment.

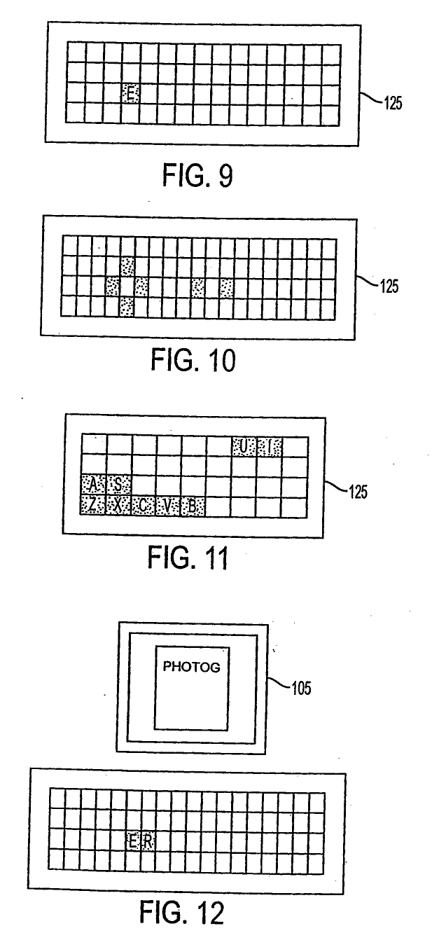

In a third example, a program executing on computing device 110 may request illumination of one or more keys to present a notification to a user. For example, the program may be an email application program. When the email application program receives an email, the email application may notify the user that an email has been received by, for example, selecting one or more keys to illuminate. Continuing the example, the email application program may select the “E” key to illuminate, as email begins with an “e.” FIG. 9 illustrates an implementation of this example where an email application program executing on computing device 110 requests illumination of the “E” key on keyboard 125 to indicate to the user that the email application program has received an email for the user. As time passes, the key's brightness may increase to draw more attention to itself. Thus, the brightness of the illuminated key may be used to convey information such as the passage of time.

In other implementations of this example, the program may constitute a first-person shooter game. In the first-person shooter game, the user's in game character may die or become injured. When the user's in-game character dies or becomes injured, the first-person shooter game may request illumination of one or more keys to notify the user that their in-game character has dies or become injured. The first-person shooter game may select a sequence of keys to illuminate in red (such as first illuminating keys in the top row of the keyboard 125, then keys in the next row down, and then keys in the row below that until the keys in the bottom row of the keyboard 125 have been illuminated) to create a visual effect of blood running down the keyboard 125 to notify the user that their in-game character died or was injured. Although this example is discussed in the context of a first-person shooter game any kind of game, such as a role-playing game, could be utilized without departing from the scope of the present disclosure.

In a fourth example, a program executing on computing device 110 may request illumination of one or more keys to indicate functionality of the program associated with the one or more keys. In one or more embodiments of this example, the program may be a first-person shooter game or other kind of game. The first-person shooter game may select keys to illuminate that are operable to influence functions of the first-person shooter game. The keys may be set statically by the first-person shooter game or may be configured by a user (such as short cut keys configured by the user for functions in the first-person shooter game). FIG. 10 illustrates an implementation of this example where one or more keys are illuminated that are operable to control the movement, firing, and other functionality associated with the first-person shooter game. In one or more embodiments of this example, the keys associated with the functionality may be set and the first-person shooter game may request illumination of the one or more keys to remind the user which keys are associated with functionality of the first-person shooter.

Alternatively, the keys associated with the functionality may change periodically and the first-person shooter game may request illumination of the one or more keys to indicate to the user which keys are currently associated with the functionality. Thus, the functionality is associated with the illumination rather than particular keys. The user is able to invoke a particular function by selecting a key that is illuminated in a way associated with a function (such as by color or brightness) rather than selecting a particular key.

In one or more other embodiments of this example, the program may be an image manipulation or classification program, such as Photoshop™. The photographic program may select keys to illuminate that are operable to influence functions of the photographic program. The photographic program may request to illuminate groups of keys associated with different groups of photographic program functions in different colors. The photographic program may determine groups of keys associated with different kinds of photographic program functions, such as image manipulation commands, storage access commands, and help commands. The photographic program may associate a color with each kind of photographic program function. The color associated with each kind of photographic program function may correspond to a color displayed for that kind of photographic program function in a drop down menu for the photographic program. The photographic program may then request to illuminate keys according to the color associated with the kind of photographic program function the keys are associated with. For example, the photographic program may request to illuminate keys associated with image manipulation commands in green, keys associated with storage access commands in blue, keys associated with help commands in red, and etc.

In a fifth example, as illustrated in FIG. 11, the program may have been provided with one or more keystrokes received from keyboard 125 and the program may request illumination of one or more keys to indicate functionality in the program when pressed simultaneously with the keys corresponding to the one or more keystrokes. The one or more keystrokes may be associated with one or more command keys and the program may request illumination of one or more keys having functionality in the program when pressed simultaneously with the command keys. For example, the keystroke may be associated with the CTRL key and the program may request illumination of one or more keys having functionality in the program when pressed simultaneously with the CTRL key. In the program, the a, s, z, x, c, v, u, and i keys may have functionality when pressed simultaneously with the CTRL key. The a key may have functionality of “select all” when pressed simultaneously with the CTRL key. The s key may have functionality of “save” when pressed simultaneously with the CTRL key. The z key may have functionality of “undo” when pressed simultaneously with the CTRL key. The x key may have functionality of “cut” when pressed simultaneously with the CTRL key. The c key may have functionality of “copy” when pressed simultaneously with the CTRL key. The v key may have functionality of “paste” when pressed simultaneously with the CTRL key. The u key may have functionality of “underline” when pressed simultaneously with the CTRL key. The i key may have functionality of “italicize” when pressed simultaneously with the CTRL key. After the program has received one or more keystrokes from the keyboard 125 indicating that the CTRL key has been pressed, the program may request illumination of the a, s, z, x, c, v, u, and i keys to illustrate that they have functionality in the program when pressed simultaneously with the CTRL key.

Further, the program may request to illuminate groups of keys associated with different groups of functions in the program when pressed simultaneously with the command keys in different colors. The program may determine groups of keys associated with different kinds of functions related to the command keys, such as storage access commands and text editing commands. The program may associate a color with each kind of function. The color associated with each kind of function may correspond to a color displayed for that kind of function in a drop down menu for the program. The program may then request to illuminate keys according to the color associated with the kind of function the keys are associated with. If the command key is the CTRL key, the program may request to illuminate the s key in blue to indicate the s key is associated with storage access commands and the a, z, x, c, v, u, and i keys in green to indicate the a, z, x, c, v, u, and i keys are associated with text editing commands.

In yet another example, the program may have been provided with one or more keystrokes received from keyboard 125 that correspond to a portion of a word. The program may analyze the portion of the word utilizing a database of words and determine possible words a user may be attempting to type based on the portion of the word. The program may compare the portion of the word to the possible words to determine what might be the next letter in the word the user may be attempting to type. The program may then select to illuminate keys corresponding to what would be the next letter. FIG. 12 illustrates an implementation of this example where the program is a word processing program. In FIG. 12, the word processing program has been provided with keystrokes from keyboard 125 corresponding to the partial word “photog” and the word processing program has requested illumination of the “E” (for “photogenic”) and “R” (for “photograph”) keys as corresponding to potential next letters for the partial word. In some implementations of this example, the program may determine a probability that a possible word is the word the user may be attempting to type by comparing the portion of the word against the possible words. The program may then illuminate different keys with different brightness and/or color based on the probability that the letter corresponding to the key is the next letter in the word. The program may brightly illuminate a first key that corresponds to a letter that has a 50% probability of being the next letter in the word, and only dimly illuminate a second key that corresponds to a letter that has only a 20% probability of being the next letter. Alternatively, different colors may be used instead of varying brightness. For example, the first key may be illuminated with a blue light and the second key with a green light.

The description above includes example systems, methods, techniques, instruction sequences, and/or computer program products that embody techniques of the present disclosure. However, it is understood that the described disclosure may be practiced without these specific details.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readably by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various examples, it will be understood that these examples are illustrative and that the scope of the disclosure is not limited to them. Many variations, modifications, additions, and improvements are possible. More generally, examples in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method of presenting user interface behaviors on an input device with individually controlled illumination input elements, the method comprising the acts of:
receiving a request for input device lighting from a program executing on a computing device;
determining illumination information for one or more light sources coupled to one or more input elements of the input device based on the request for input device lighting; and
dynamically controlling illumination of the one or more light sources based on the determined illumination information.

2. The method of claim 1, wherein the illumination information comprises at least one selected from the group comprising brightness of the one or more light sources, color of the one or more lights sources, or duration of the one or more light sources.

3. The method of claim 1, wherein said receiving a request for input device lighting from a program executing on a computing device comprises:
receiving one or more input element selections associated with the program from the input device; and
notifying the program of the one or more input element selections.

4. The method of claim 3, wherein the input device comprises a keyboard, the one or more input selections comprises one or more keystrokes, and the request for input device lighting is based on the one or more keystrokes.

5. The method of claim 4, wherein the one or more keystrokes corresponds to at least a portion of a word and dynamically controlling illumination of the one or more light sources comprises dynamically controlling illumination of one or more light sources coupled to one or more keys corresponding to potential next letters of the word.

6. The method of claim 5, wherein dynamically controlling illumination of one or more light sources coupled to one or more keys corresponding to potential next letters of the word comprises dynamically controlling at least one selected from the group comprising brightness, color, and duration of the one or more light sources coupled to a key based on a probability that the key corresponds to the next letter of the word.

7. The method of claim 4, wherein the one or more keystrokes correspond to a command key and dynamically controlling illumination of the one or more light sources comprises dynamically controlling illumination of one or more light sources coupled to one or more keys associated with the command key.

8. The method of claim 1, wherein dynamically controlling illumination of the one or more light sources comprises dynamically controlling illumination of one or more light sources coupled to one or more input elements associated with a functionality of the program.

9. The method of claim 1, wherein said dynamically controlling illumination of the one or more light sources based on the determined illumination information comprises:
dynamically controlling illumination of the one or more light sources to present a notification associated with the program on the input device.

10. The method of claim 1, wherein said dynamically controlling illumination of the one or more light sources based on the determined illumination information comprises:
dynamically controlling illumination of the one or more light sources to present a graphic equalizer on the input device.

11. The method of claim 1, wherein said dynamically controlling illumination of the one or more light sources based on the determined illumination information comprises:
dynamically controlling illumination of the one or more light sources to present a display on the input device, the display corresponding to at least a portion of an image displayed on a display device coupled to the computing device.

12. A system comprising:
an input device, the input device comprising:
a plurality of input elements; and
a plurality of light sources coupled to the plurality of input elements; and
a computing device, coupled to the input device, the computing device comprising:
a program executing on the computing device; and
an input device lighting driver, executing on the computing device, operable to receive a request for input device lighting from the program and to provide one or more input elements selections associated with the program, received from the input device, to the program;
wherein the input device lighting driver determines illumination information for one or more light sources coupled to the one or more input elements of the input device based on the request for input device lighting and dynamically controls illumination of the one or more light sources based on the determined illumination information.

13. The system of claim 12, wherein the input device comprises a keyboard, the one or more input element selections comprises one or more keystrokes, and the request for input device lighting is based on the one or more keystrokes.

14. The system of claim 13, wherein the one or more keystrokes corresponds to at least a portion of a word and the input device lighting driver dynamically controls illumination of the one or more light sources coupled to one or more keys corresponding to potential next letters of the word.

15. The system of claim 14, wherein the input device lighting driver dynamically controls at least one selected from the group comprising brightness, color, and duration of the one or more light sources coupled to a key based on a probability that the key corresponds to the next letter of the word.

16. The system of claim 13, wherein the one or more keystrokes correspond to a command key and the input device lighting driver dynamically controls illumination of the one or more light sources coupled to one or more keys associated with the command key.

17. The system of claim 12, wherein the input device lighting driver dynamically controls illumination of the one or more light sources coupled to one or more input elements associated with a functionality of the program.

18. The system of claim 12, wherein the input device lighting driver dynamically controls illumination of the one or more light sources to present a notification associated with the program on the input device.

19. The system of claim 12, wherein the input device lighting driver dynamically controls illumination of the one or more light sources to present a graphic equalizer on the input device.

20. The system of claim 12, wherein the input device lighting driver dynamically controls illumination of the one or more light sources to present a display on the input device, the display corresponding to at least a portion of an image displayed on a display device coupled to the computing device.
